(19) United States
(12) Patent Application Publication
(10) Pub. No.: US 2007/0018717 A1
(43) Pub. Date: Jan. 25, 2007

(54) Method and device for demodulating a phase modulated signal

(75) Inventors: Martin Friedrich, Gelsenkirchen (DE); Christian Grewing, Sollentuna (SE); Giuseppe Li Puma, Bochum (DE); Christoph Sandner, Villach (AT); Andreas Wiesbauer, Portschach (AT); Kay Winterberg, Kempen (DE); Stefan Van Waasen, Sollentuna (SE)

Correspondence Address: MAGINOT, MOOR & BECK, 111 MONUMENT CIRCLE, SUITE 3000, BANK ONE CENTER/TOWER, INDIANAPOLIS, IN, 46204, US

(73) Assignee: Infineon Technologies AG, München (DE)

(21) Appl. No.: 10/543,268

(22) PCT Filed: Sep. 17, 2004
(86) PCT No.: PCT/EP04/10464

§ 371 Date: Aug. 18, 2006

(30) Foreign Application Priority Data
Dec. 23, 2003 (DE) 103 61 037.5

(51) Int. Cl. H04L 27/22

(52) U.S. Cl. 329/304

(57) ABSTRACT

A phase-modulated signal (1) is divided into an in-phase component and a quadrature-phase component. The in-phase component is supplied to a first one-bit analogue/digital converter (25) and the quadrature-phase component is supplied to a second one-bit analogue/digital converter (26), output signals (8; 9) of the one-bit analogue/digital converters (26; 27) being evaluated for determining data modulated onto the phase-modulated signal (1). The one-bit analogue/digital converters may be constructed as simple comparators (26; 27).

The present invention relates to a method for demodulating a phase-modulated signal and to a device that is constructed according to the method and may be used, in particular, in receivers that are used for wireless communication and support the ultra-wideband standard (UWB).

The UWB is based on a multichannel frequency hopping (MFH) method and uses phase shift keying (PSK), quadrature phase shift keying (QPSK), which is also known as 4-PSK, usually being used as the phase shift keying. The UWB standard operates in a frequency range from 3.1 GHz to 10.6 GHz.

Receivers according to the prior art operating to the UWB standard amplify the signal, which has previously been filtered using a bandpass filter, using a low-noise amplifier before they supply it to an analogue mixer for frequency down-mixing. The resulting signal is then further filtered within the receiver operating to the UWB standard using an analogue channel filter, amplified by means of a programmable amplifier and converted using a multibit analogue/digital converter into a digital signal, which is then further evaluated in order to capture data modulated onto the phase-modulated signal.

The production of a rapid multibit analogue/digital converter, in which the 130 nm CMOS technology that is nowadays mainly used may be utilised, is highly problematic on account of the high power consumption.

The object of the invention is therefore to provide a method and a device for demodulating a phase-modulated signal that solves this problem.

According to the invention, this object is achieved by a method according to claim 1 or by a demodulation device according to claim 10. The dependent claims define preferred and advantageous configurations of the invention.

According to the present invention, a phase-modulated signal is mixed, on the one hand, with a first signal having an intermediate frequency, thus producing a first intermediate signal, which corresponds to an in-phase component of the phase-modulated signal. On the other hand, the phase-modulated signal is mixed with a second signal, which corresponds to the first signal, when it is out-of-phase by 90°, thus producing a second intermediate signal, which corresponds to a quadrature-phase component of the phase-modulated signal. Both the first intermediate signal and the second intermediate signal are then filtered. A resulting first filtered intermediate signal is supplied to a first one-bit analogue/digital converter and a second filtered intermediate signal is supplied to a second one-bit analogue/digital converter, wherein both the first filtered intermediate signal and the second filtered intermediate signal may be amplified before being supplied to the corresponding one-bit analogue/digital converter. An output signal of the first one-bit analogue/digital converter and an output signal of the second one-bit analogue/digital converter are evaluated for determining data modulated onto the phase-modulated signal.

As a rapid one-bit analogue converter may be constructed substantially more simply than a rapid multibit analogue/digital converter, the power consumption of a one-bit analogue converter is substantially lower than that of a multibit analogue/digital converter. The demodulation method according to the invention therefore has lower power consumption than demodulation methods according to the prior art that use multibit analogue/digital converters. It is therefore in principle simpler to carry out the demodulation method according to the invention using relatively small transistor structures than a demodulation method operating according to the prior art that uses a multibit analogue/digital converter.

According to the invention, both the amplitude of the first filtered intermediate signal and the amplitude of the second filtered intermediate signal may be compared with a reference value. The first output signal may be equated with a first predetermined value if the amplitude of the first filtered intermediate signal is greater than the reference value, and otherwise the first output signal may be equated with a second predetermined value. In the same way, the second output signal may be equated with the first predetermined value if the amplitude of the second filtered intermediate signal is greater than the reference value, and otherwise the second output signal may be equated with the second predetermined value. The first predetermined value may be equal to “1”, the second predetermined value equal to “−1” and the reference value equal to “0”.

A part of the demodulation method according to the invention that forms the first or second output signal from the analogue first or second filtered intermediate signal advantageously corresponds to a simple comparative method, which may be carried out in a very simple manner precisely when the first predetermined value is equal to “1”, the second predetermined value equal to “−1” and the reference value equal to “0”.

The intermediate frequency may also be a multiple of a data rate at which data are modulated onto the phase-modulated signal. In particular, the intermediate frequency may be selected such that a device that carries out the demodulation method according to the invention is optimised to a low energy consumption at a predetermined settling time with which the first and the second filtered intermediate signals settle on the basis of a variation in a carrier frequency of the phase-modulated signal.

The demodulation of the phase-modulated signal is simplified if the intermediate frequency is set at a multiple of the data rate at which data are modulated onto the phase-modulated signal.

The lower the first or second intermediate signal is mixed down, i.e. the lower the intermediate frequency is selected, the longer the settling time with which the first and/or second intermediate signals settle as a result of a variation in a carrier frequency of the phase-modulated signal. On the other hand, the higher the intermediate frequency, the higher the power consumption of a device that uses the demodulation method according to the invention. As the settling time is determined by standards (for example, UWB), the intermediate frequency is advantageously selected such that the settling time determined by a standard that is used is adhered to.

A further aspect to be considered is the elimination of the effects of a DC component on the first or second intermediate signal, as the effects of the DC component disrupt the part of the demodulation method according to the invention that obtains the first or second output signal from the analogue first or second filtered intermediate signal. The intermediate frequency is therefore advantageously greater than a frequency resulting from the data rate of the data modulated onto the phase-modulated signal; i.e. the intermediate frequency should not be selected so as to be identical to a frequency corresponding to the data rate.

Moreover, according the invention, the first output signal may be multiplied by a first sampled signal, which periodically passes through the values 1, 0, −1 and 0 in the specified sequence, thus producing a first multiplied output signal, which is lowpass-filtered, thus producing a first lowpass-filtered output signal. In the same way, the second output signal may be multiplied by a second sampled signal, which periodically assumes the values 0, 1, 0 and −1 in the specified sequence, thus producing a second multiplied output signal, which is lowpass-filtered, thus producing a second lowpass-filtered output signal. The frequency F_{A} of the first and the second sampled signal is identical and is in the following relation to the intermediate frequency F_{ZF}:
F_{ZF}=k*F_{A}±F_{A}/4 wherein k=0, 1, 2, 3, . . . .

The multiplication of the first or second output signal may also be viewed as a simple sorting (and not as a genuine multiplication) of the first or second output signal, and this allows a simpler configuration. In this case, instead of the multiplication by 0, a corresponding value of the first or second output signal is skipped or deleted, instead of a multiplication by 1, a corresponding value of the first or second output signal is passed on, and instead of a multiplication by −1, a corresponding value of the first or second output signal is passed on in inverted form. This simplification is described in detail in WO 01/60007 A1.

The first and second lowpass-filtered output signals are used for determining the data modulated onto the phase-modulated signal.

As the period of both the first and the second sampled signal is in each case only four values long and these values have a very simple value range (−1, 0, 1), which, precisely in the case of transistor circuits, is very simple to present, multiplication of the first output signal by the first sampled signal or the second output signal by the second sampled signal is very simple. Assuming that the first or second output signal only assumes the values −1 and 1, there are only six combinations when multiplying the first or second output signal by the first or second sampled signal, the value range of the result of the multiplication being identical to the value range of the first or second sampled signal.

According to the present invention, a demodulation device for demodulating a phase-modulated signal comprises a first and second mixer, a first and second channel filter and a first and second one-bit analogue/digital converter. The phase-modulated signal may be fed in each case to a first input of the first mixer and to a second input of the second mixer. At the same time, a first signal having an intermediate frequency is fed to a second input of the first mixer and a second signal, which corresponds to the first signal, when it is out-of-phase by 90°, is supplied to a second input of the second mixer. An output signal of the first mixer corresponds to an in-phase component of the phase-modulated signal, and an output signal of the second mixer corresponds to a quadrature-phase component of the phase-modulated signal. In addition, the output signal of the first mixer may be supplied to an input of the first channel filter, and the output signal of the second mixer may be supplied to an input of the second channel filter. An output signal of the first channel filter may be supplied to the first one-bit analogue/digital converter, and an output signal of the second channel filter may be supplied to the second one-bit analogue/digital converter. The demodulation device is constructed such that it evaluates an output signal of the first one-bit analogue/digital converter and an output signal of the second one-bit analogue/digital converter for determining data modulated onto the phase-modulated signal.

As a result of the use of one-bit analogue/digital converters, the construction of the demodulation device according to the invention is simpler and may be carried out using small transistor structures (130 nm) such as are currently used, even if stringent demands are placed on the operating speed and hence on the power consumption of the demodulation device. In the case of a demodulation device according to the prior art, this involves high production costs, as the construction is substantially more complex than the demodulation device according to the invention and therefore has higher power requirements at high operating speeds, resulting in high power consumption in the case of the small transistor structures that are nowadays used.

In a preferred embodiment of the demodulation device according to the invention, both the first and the second one-bit analogue/digital converter may be constructed such that it decides, on the basis of an amplitude quantification of an applied input signal, which of two possible values its output signal assumes. Therefore, in a simplified but preferred embodiment, both the first and the second one-bit analogue/digital converter may be a comparator. A limiting amplifier, which raises the signal level at the output of the first I/Q mixer pair by a required degree, is connected upstream of each comparator. The corresponding limiting amplifier is usually arranged after the first or second channel filter.

If the two one-bit analogue/digital converters are each formed by a comparator, a one-bit analogue/digital converter may be very simple in its construction. The above-mentioned advantages with respect to the simple construction and hence the power consumption are thus further enhanced.

The demodulation device according to the invention may also comprise an oscillator, which generates the first signal having the intermediate frequency and comprises a phase-shift device, which, starting from the first signal, generates the second signal, which is out-of-phase by 90°.

In order not to hinder the mode of operation of the first and second one-bit analogue/digital converters, specifically when they are constructed as comparators, care should be taken that the various elements of the demodulation device are, as far as possible, coupled to one another with AC voltage in order to eliminate DC components. An excessively high DC component hinders the operation of a comparator because a comparison, taking place in the comparator, of a signal value with, for example, 0 is distorted by the DC component. In order to allow the various elements of the demodulation device to be coupled to one another with AC voltage, the intermediate frequency should be selected so as not to be identical to a frequency corresponding to the data: rate at which data are modulated onto the phase-modulated signal. In other words, the intermediate frequency should advantageously be selected so as to be greater than the frequency corresponding to the data rate.

The demodulation device may further comprise a first and a second digital multiplier. An output signal of the first one-bit analogue/digital converter may be supplied to a first input of the first digital multiplier, and an output signal of the second one-bit analogue/digital converter may be supplied to a first input of the second digital multiplier. Assuming that the output signal of the first one-bit analogue/digital converter and the output signal of the second one-bit analogue/digital converter only assume the values −1 and 1, and that the first sampled signal may be supplied to a second input of the first multiplier and the second sampled signal may be supplied to a second input of the second multiplier, both the first and the second digital multipliers have only to carry out the following calculations:

$$- 1 * - 1 = 1 ; - 1 * 0 = 0 ; - 1 * 1 = - 1 ; 1 * - 1 = - 1 ; 1 * 0 = 0 ; 1 * 1 = 1$$

Both the first and the second digital multipliers may thus be produced in a very simple manner and therefore with low power consumption.

The present invention is preferably suitable for use in receivers that meet the UWB standard. However, it is of course not limited to this preferred application.

The present invention will be described below in greater detail, on the basis of a preferred embodiment, with reference to the accompanying drawing, in which:

The single FIGURE is a schematic illustration of a demodulation device according to the invention.

The single FIGURE shows a demodulation device 40 such as may be used, for example, in an MFH system based on the UWB standard. It should be assumed that data have been modulated onto a signal, these data having been modulated, for example, at a data rate or pulse rate of 1/220 MHz, which corresponds to 4.5455 ns, using phase shift keying (for example BPSK or QPSK). The mid frequencies of individual bands on the signal are located at frequencies that are specified by the following formula:
3520 MHz+(N−1)×440 MHz wherein N=1, 2, 3 . . .

N denotes the respective individual frequency band on the signal. The signal is filtered by a channel filter 34 and amplified using an amplifier 35, an amplified phase-modulated signal 1 being adjusted at the output of the amplifier 35.

In the case of the demodulation device 40, which comprises an analogue front end 36 and a digital baseband device 37, this phase-modulated signal 1 is supplied to a first input of a first mixer 21 and to a first input of a second mixer 22. A local oscillator 27 generates a first signal 2 having an intermediate frequency F_{ZF}. A second signal 3, which is out-of-phase by 90° relative to the first signal 2, is generated using a phase-shift device 28. The first signal 2 is supplied to a second input of the first mixer 21, and the second signal 3 is supplied to a second input of the second mixer 22. A first intermediate signal 4, which corresponds to an in-phase component of the phase-modulated signal 1, may be tapped at the output of the first mixer 21, whereas a second intermediate signal 5, which corresponds to a quadrature-phase component of the phase-modulated signal 1, may be tapped at the output of the second mixer 22. The first intermediate signal 4 is then filtered using a first bandpass filter or channel filter 23, and the second intermediate signal 5 is filtered using a second bandpass filter or channel filter 24, the filtered-out frequency band corresponding to the selected intermediate frequency F_{ZF}.

Both the first and the second channel filters are a polyphase filter or multiphase filter 23, 24, the strong point of which is precisely the demodulation of audio data. In order to allow recognition of the modulated data, these polyphase filters 23, 24 must be of sufficient quality to allow adequate elimination of adjacent sidebands and disturbances outside the filtered frequency band.

In order to attain a coherent phase relationship between the first signal 2 or the second signal 3 and the phase-modulated signal, the intermediate frequency F_{ZF} has to correspond to a multiple of a frequency corresponding to the data rate. In the case of the present embodiment, the intermediate frequency F_{ZF} should thus be adjusted to a multiple of 220 MHz (220 MHz, 440 MHz, 660 MHz, 880 MHz, etc.). Nevertheless, when selecting the intermediate frequency F_{ZF}, it should be borne in mind that the higher the selected intermediate frequency, the higher the power consumption of the demodulation device. Moreover, it should be considered that the demodulation device 40, as previously noted, pertains to an MFH system based on the UWB standard, and this means that the demodulation device 40, in accordance with the UWB standard, has to adjust rapidly to an altered carrier frequency of the phase-modulated signal 1. It should be borne in mind that the adjustment time of a bandpass filter increases as the frequency of the band to be filtered decreases. A compromise therefore has to be reached between power consumption and a rapid adjustment time, which is determined by the UWB standard. In the case of the present embodiment, this compromise was reached at an intermediate frequency F_{ZF} of 660 MHz.

The first filtered intermediate signal 6 is issued to a first comparator 25, and the second filtered intermediate signal 7 is issued to a second comparator 26. Both comparators 25, 26 compare whether their input signal has a value that is greater than the value 0 and, if this is the case, set the value of their output signal to the value 1, and otherwise to the value −1. The output signal 8 of the first comparator 25, which will also be referred to below as the first output signal 8, is thus also a rectangular signal, which has the same zero crossings as the first filtered intermediate signal 6. In the same way, the output signal 9 of the second comparator 26, which will also be referred to below as the second output signal 9, is a rectangular signal, which has the same zero crossings as the second filtered intermediate signal 7.

If a rectangular signal 8, 9 is generated from the respectively filtered intermediate signal 6, 7 by the respective comparator 25, 26, the proposed demodulation device 40 could exhibit a slightly smaller signal-to-noise distance for a given bit error rate than a demodulation device produced according to the prior art, which operates with multibit analogue/digital converters instead of the comparators 25, 26 and can thus more accurately grade an amplitude of the first output signal 8 or second output signal 9. However, this signal-to-noise distance is more than compensated by the very low power consumption and by a configuration of the demodulation device 40 involving very few surfaces.

In order to down-mix the first output signal or rectangular signal 8 onto the baseband, it is guided, together with a first sampled signal 10, onto a first digital multiplier 29. For the same purpose, the second output signal or rectangular signal 9 is guided, together with a second sampled signal 11, onto a second digital multiplier 30. The first sampled signal 10 periodically assumes the values 1, 0, −1, 0 in the specified sequence, whereas the second sampled signal 11 periodically assumes the values 0, 1, 0, −1 in the specified sequence. The frequency F_{A} of the first sampled signal 10 or the second sampled signal 11 is identical and, in order to facilitate implementation of the digital multiplier 29, 30, is in the following relationship to the intermediate frequency F_{ZF}:
F_{ZF}=k*F_{A}±F_{A/}4 wherein k=0, 1, 2, 3, . . .

The function of the first sampled signal 10 may therefore also be described by cos (2π*F_{ZF}*n/F_{A}), n being a control variable that passes through the values 0, 1, 2, 3, etc.

In the same way, the function of the second sampled signal 11 may be described by sin (2π*F_{ZF}*n/F_{A}), n being the same control variable as in the case of the first sampled signal 10.

If the first output signal 8 is multiplied by the first sampled signal 10 thus configured or the second output signal 9 is multiplied by the second sampled signal 11 thus configured at moments determined by the frequency of the sampled signals, scanned values are taken from the first output signal 8 or second output signal 9 and substantially sorted.

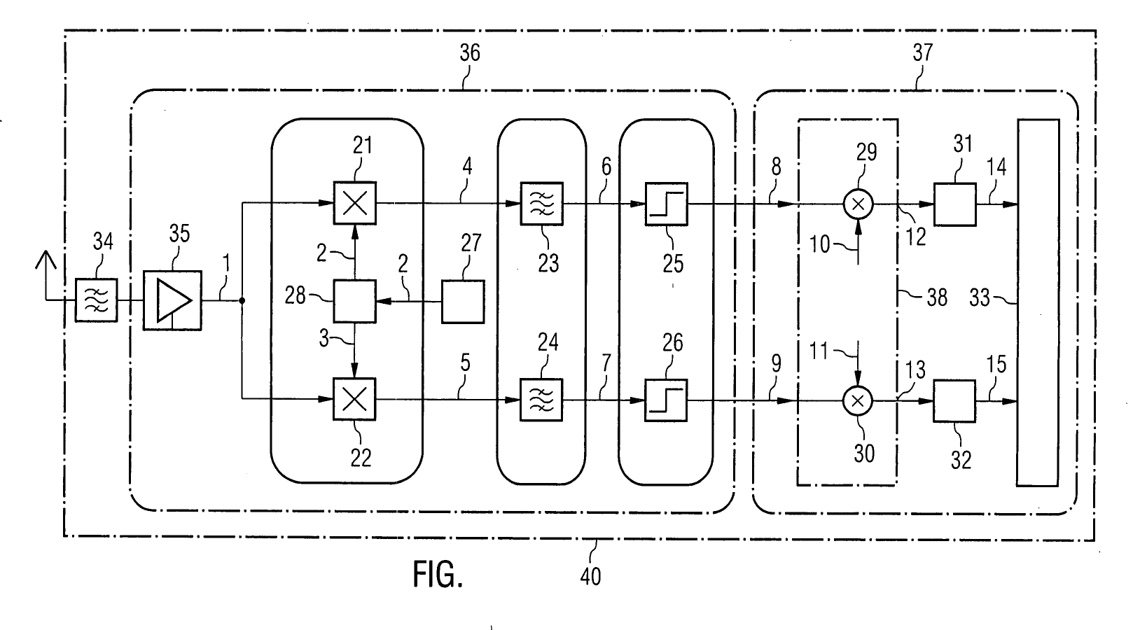

In the figure, a reference numeral 38 denotes a device for digital frequency conversion into the baseband. For the sake of simplicity, this digital frequency conversion is in this case illustrated only for the real portion. A device for complex-valued digital frequency conversion into the baseband, as is illustrated, for example, in FIG. 8a of the article “Low-IF Topologies for High Performance Analog Front Ends of Fully Integrated Receivers”, IEEE Transactions on Circuits and Systems II, Analog and Digital Signal Processing, Vol. 45, Issue 3, March 1998, pages 269-282 may of course also be used in the case of the present demodulation device 40.

An output signal 12 of the first digital multiplier 29 is then issued to an input of a first digital lowpass filter 31, whereas an output signal 13 of the second digital multiplier 30 is issued to an input of a second digital lowpass filter 32. Finally, an output signal of the first digital lowpass filter 31 and an output signal of the second digital lowpass filter 32 are supplied to an evaluation device 33. This evaluation device 33 operates using methods known from the prior art (for example, channel estimation) in order separately to reconstruct from the output signal 14 of the first lowpass filter 31, which is also referred to as the I-baseband signal, and from the output signal 15 of the second lowpass filter 32, which is also referred to as the Q-baseband signal, the data modulated onto the phase-modulated signal 1 into the in-phase component and quadrature-phase component. The modulated data are then produced from these two components.

1-28. (canceled)

29. A method, comprising:
a) mixing a phase-modulated signal with a first signal having an intermediate frequency to produce a first intermediate signal and mixing the phase-modulated signal being mixed with a second signal, which corresponds to the first signal out-of-phase by 90°, to produce a second intermediate signal,
b) generating a first output signal using a first one-bit analog/digital conversion on the first intermediate signal,
c) generating a second output signal using a second one-bit analog/digital conversion on the second intermediate signal, and
d) determining data modulated onto the phase-modulated signal based on an evaluation of the first output signal and the second output signal.

30. The method according to claim 29, wherein step b) further comprising comparing an amplitude of the first intermediate signal with a reference value and generating the first output signal at a first predetermined value if the amplitude is greater than the reference value, and generating the first output signal at a second predetermined value if the amplitude is less than the reference value.

31. The method according to claim 30, wherein the first predetermined value is equal to “11” and the second predetermined value is equal to “−1”.

32. The method according to claim 30, characterized in that the reference value is equal to 0.

33. The method according to claim 29, wherein the phase modulated signal includes a data rate at which the data is modulated, and wherein the intermediate frequency is a multiple of the data rate.

34. The method according to claim 33, wherein the intermediate frequency comprises a least of a plurality of multiples of the data rate that results in at least a predetermined settling time, the predetermined settling time corresponding to a time in which the first and the second filtered intermediate signals settle on the basis of a variation in a carrier frequency of the phase-modulated signal.

35. The method according to claim 29, wherein step d) further comprises:
multiplying the first output signal by a first sampled signal, which periodically assumes the values “1”, “0”, “−1” and “0” in specified sequence, to produce a first multiplied output signal, and
multiplying the second output signal by a second sampled signal, which periodically assumes the values “0”, “1”, “0” and “−1” in specified sequence, thus producing a second multiplied output signal.

36. The method according to claim 35, wherein multiplying the first output signal by factors “1”, “0” or “−1” is carried out by sorting the first output signal.

37. The method according to claim 35, wherein step d) further comprises:
lowpass filtering the first multiplied output signal to produce a first lowpass-filtered output signal,
lowpass filtering the second multiplied output signal to produce a second lowpass-filtered output signal, and
evaluating the first and second lowpass-filtered output signals in order to determine the data modulated onto the phase-modulated signal.

38. The method according to claim 35, wherein a frequency (F_{A}) of the first and second sampled signals is identical and satisfies the following equation for the intermediate frequency (F_{ZF}):
F_{ZF}=k*F_{A}+F_{A}/4 (wherein k=0, 1, 2, 3, . . . )

39. The method according to claim 38, wherein the first sampled signal is formed by the function cos (2π*F_{ZF}*n/F_{A}) and in that the second sampled signal is formed by the function sin (2π*F_{zF}*n/F_{A}), n being a control variable.

40. The method according to claim 29, further comprising, prior to step a), filtering and amplifying the phase-modulated signal.

41. The method according to claim 29, further comprising, prior to step b), filtering and amplifying the first intermediate signal, and prior to step c), filtering and amplifying the second intermediate signal.

42. The method according to claim 29, further comprising, prior to step b), filtering the first intermediate signal, and prior to step c), filtering the second intermediate signal.

43. A demodulation device for demodulating a phase-modulated signal, the demodulation device comprising:
a first mixer configured to mix the phase-modulated signal with a first signal having an intermediate frequency to generate a first intermediate signal;
a second mixer configured to mix the phase-modulated signal with a second signal having the intermediate frequency and being 90° out-of-phase with the first signal, to generate a second intermediate signal,
a first one-bit analog/digital converter operably coupled to perform a conversion of the first intermediate signal to generate a first output signal;
a second one-bit analog/digital converter operably coupled to perform a conversion of the second intermediate signal to generate a second output signal; and
a baseband circuit configured to evaluate the first output signal and the second output signal to determine data modulated onto the phase-modulated signal.

44. The demodulation device according to claim 43, wherein the first one-bit analog/digital converter is configured to generate the first output signal as one of two possible values based on an amplitude quantisation of the first intermediate signal.

45. The demodulation device according to claim 44, wherein the two possible values of the first output signal are the values “−1” and “1”.

46. The demodulation device according to claim 44, wherein the first one-bit analog/digital converter is configured to generate a first the two possible values for the first output signal if the amplitude of first intermediate signal is greater than 0, and generate a second of the two possible values if the amplitude of the first intermediate signal is less than 0.

47. The demodulation device according to claim 43, wherein the first one-bit analog/digital converter comprises a comparator.

48. The demodulation device according to claim 43, further comprising an oscillator operably coupled to provide the first signal to the first mixer and to a phase-shift device, and wherein the phase-shift device is operable to generate the second signal from the first signal, and is operably coupled to provide the second signal to the second mixer.

49. The demodulation device according to claim 43, further comprising a first channel filter operably coupled between the first mixer and the first one-bit analog/digital converter, and a second channel filter operably coupled between the second mixer and the second one-bit analog/digital converter.

50. The demodulation device according to claim 43, wherein the baseband circuit includes a first digital multiplier operably coupled to multiply the first output signal and a first sampled signal, which periodically passes through the values “1”, “0”, “−1” and “0” in sequence, and a second digital multiplier operably coupled to multiply the second and a second sampled signal, which periodically passes through the values “1”, “0”, “−1” and “0” in sequence.

51. The demodulation device according to claim 50, wherein the first digital multiplier is configured as a first sorter constructed such that it carries out the multiplication by factors “1”, “1” or “−1” by sorting the first output signal.

52. The demodulation device according to claim 50, characterized in that the frequency, F_{A}, of the first and second sampled signal is identical and satisfies the following equation for the intermediate frequency, F_{ZF}:
F_{ZF}=k*F_{A}±F_{A}/4 (wherein k=0, 1, 2, 3, . . . )

53. The demodulation device according to claim 50, wherein the baseband circuit further comprises a first lowpass filter operably coupled to receive an output of the first multiplier and a second lowpass filter operably coupled to receive an output of the second multiplier, and an the evaluation device coupled to receive outputs of the first and a second lowpass filters and configured to determine as a function thereof the data modulated onto the phase-modulated signal.

54. The demodulation device according to claim 49, wherein the first and the second channel filter is a respective polyphase filter.

55. The demodulation device according to claim 49, further comprising a further channel filter and an amplifier operably coupled to amplify and filter the phase-modulated signal and configured to provide the amplified and filtered to at least the first mixer.

56. The demodulation device according to claim 49, further comprising a first limiting amplifier coupled between the first channel filter and the first one-bit analog/digital converter, and a second limiting amplifier coupled between the second channel filter and the second one-bit analog/digital converter.
